(19) United States
(12) Patent Application Publication
(10) Pub. No.: US 2026/0279330 A1
(43) Pub. Date: Sep. 17, 2026

(54) ELECTRONIC DEVICE, ELECTRONIC DEVICE SYSTEM, AND INTONATION CONTROL METHOD

(71) Applicant: CASIO COMPUTER CO., LTD., Tokyo (JP)

(72) Inventors: Makoto DANJYO, Tokyo (JP); Fumiaki OTA, Tokyo (JP); Atsushi NAKAMURA, Tokyo (JP)

(73) Assignee: CASIO COMPUTER CO., LTD., Tokyo (JP)

(21) Appl. No.: 19/565,844

(22) Filed: Mar. 13, 2026

(30) Foreign Application Priority Data
Mar. 13, 2025 (JP) 2025-040392

(51) Int. Cl. G10L 13/033

(52) U.S. Cl. CPC G10L 13/0335

(57) ABSTRACT

An electronic device includes at least one processor. The at least one processor: acquires: first pitch data corresponding to a pitch specification operation by a user on an operating element; syllable data that includes a plurality of syllables; and an intonation note level for each of the plurality of syllables, the intonation note level being specified by the user from among a plurality of intonation note levels corresponding to a respective plurality of pitches; generates voice waveform data corresponding to the each of the plurality of syllables based on second pitch data obtained by changing the first pitch data according to the intonation note level for the each of the plurality of syllables; and causes a vocalizer to vocalize based on the voice waveform data.

### CROSS-REFERENCE TO RELATED APPLICATION

The present application claims priority under the Paris Convention to Japanese Patent Application No. 2025-040392, filed on Mar. 13, 2025, the disclosure of which, including the description, claims, abstract, and drawings, is incorporated herein by reference in its entirety.

### BACKGROUND OF THE INVENTION

### Technical Field

The present invention relates to an electronic device, an electronic device system, and an intonation control method.

### Description of Related Art

In recent years, the use cases for synthetic voices have expanded. Amidst this trend, for example, JP 2020-148914A describes an electronic keyboard instrument capable of vocalizing rap voices composed of multiple syllables with intonations applied according to specified intonation patterns.

### SUMMARY OF THE INVENTION

An electronic device according to the present disclosure comprises at least one processor, wherein the at least one processor: acquires: first pitch data corresponding to a pitch specification operation by a user on an operating element; syllable data that includes a plurality of syllables; and an intonation note level for each of the plurality of syllables, the intonation note level being specified by the user from among a plurality of intonation note levels corresponding to a respective plurality of pitches; generates voice waveform data corresponding to the each of the plurality of syllables based on second pitch data obtained by changing the first pitch data according to the intonation note level for the each of the plurality of syllables; and causes a vocalizer to vocalize based on the voice waveform data.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a diagram illustrating an overall configuration of an electronic device system according to the present disclosure;

FIG. 2 is a diagram illustrating the appearance of an electronic musical instrument shown in FIG. 1;

FIG. 3 is a block diagram illustrating a functional configuration of the electronic musical instrument shown in FIG. 1;

FIG. 4 is a block diagram illustrating a functional configuration of a terminal device shown in FIG. 1;

FIG. 5A is a diagram illustrating an intonation note setting screen when the emotional expression is “Normal”;

FIG. 5B is a diagram illustrating the intonation note setting screen when the emotional expression is “Sad”;

FIG. 5C is a diagram illustrating the intonation note setting screen when the emotional expression is “Happy (Angry)”;

FIG. 6 is a diagram illustrating an intonation note setting table;

FIG. 7 is a diagram illustrating the relationship between syllables and frames;

FIG. 8 is a flowchart illustrating a flow of intonation control processing executed by a CPU of the electronic musical instrument shown in FIG. 1;

FIG. 9A is a schematic diagram illustrating a pitch change due to knob rotation;

FIG. 9B is a schematic diagram illustrating a pitch change due to knob rotation;

FIG. 9C is a schematic diagram illustrating a pitch change due to knob rotation; and

FIG. 10 is a flowchart illustrating a flow of singing voice synthesis processing executed by the CPU of the electronic musical instrument shown in FIG. 1.

### DETAILED DESCRIPTION

An electronic device according to the present disclosure has the advantage that each character set containing a syllable can be vocalized with an intonation desired by a user.

Hereinafter, one or more embodiments of the present invention will be described with reference to the drawings. However, the embodiments described below are subject to various technically preferred limitations for implementing the present invention. Therefore, the technical scope of the present invention is not limited to the following embodiments and illustrated examples. The electronic device according to the present disclosure includes an electronic musical instrument.

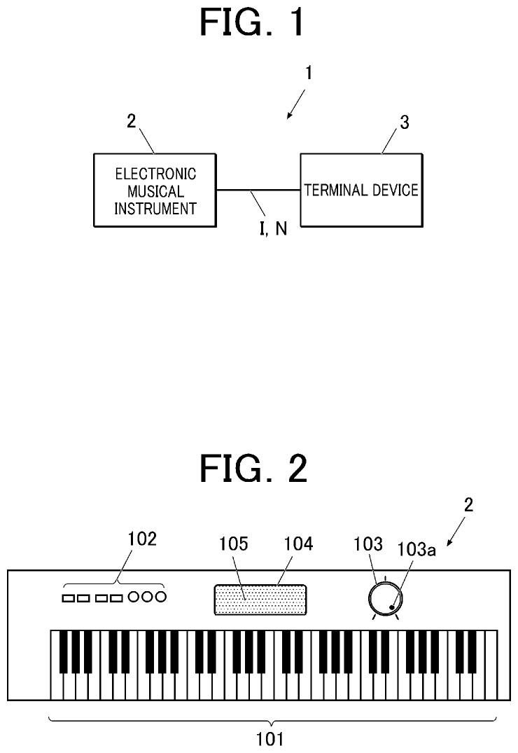

As illustrated in FIG. 1, an electronic device system 1 according to the present embodiment includes an electronic musical instrument 2 (first electronic device) and a terminal device 3 (second electronic device) connected via a communication interface I (or a communication network N).

The electronic musical instrument 2 has a singing voice vocalization mode, in addition to a normal mode that outputs instrument sounds in response to a key press operation (pitch specification operation) by a user on a keyboard 101. In the singing voice vocalization mode, the electronic musical instrument 2 vocalizes a singing voice in response to a key press operation on the keyboard 101. In the present specification, “singing voice” and “voice” are used interchangeably.

As illustrated in FIG. 2, the electronic musical instrument 2 includes the keyboard 101 having a plurality of keys as operating elements, a switch panel 102 that instructs mode selection and various settings, a knob 103 (adjuster) that adjusts the magnitude of pitch deviation, a liquid crystal display (LCD) 104 (display) that displays various information, and a touch panel 105 provided on the surface of the LCD 104. Furthermore, the electronic musical instrument 2 includes a speaker 214 on its rear surface, side surface, back surface, or the like that emits musical sounds and voices (singing voices) generated by performance.

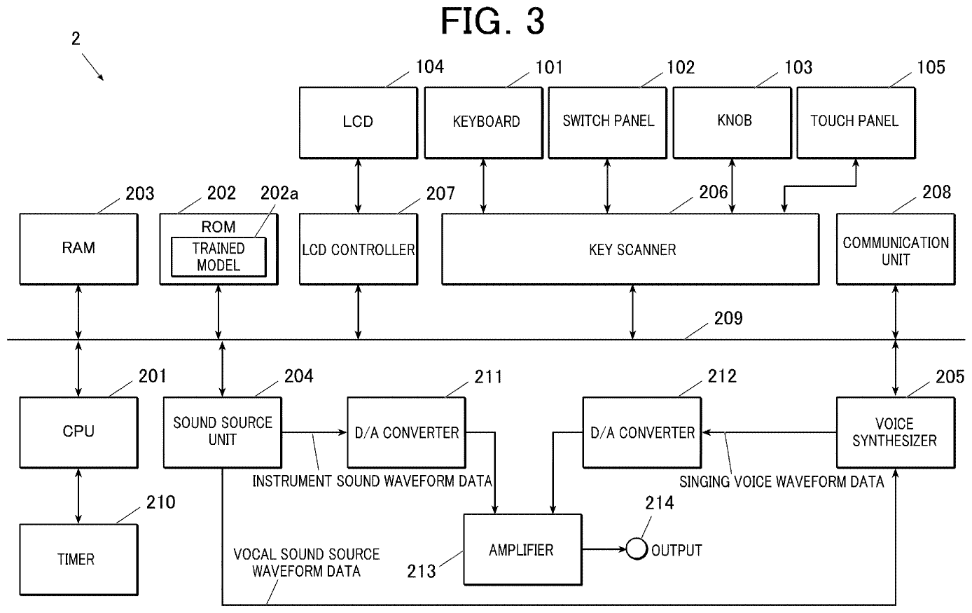

As illustrated in FIG. 3, the electronic musical instrument 2 includes a central processing unit (CPU) 201 as at least one processor, a read-only memory (ROM) 202, a random-access memory (RAM) 203, a sound source unit 204, a voice synthesizer 205, a key scanner 206, an LCD controller 207, and a communication unit 208. Each of these components is connected to a bus 209. The CPU 201 is connected to a timer 210. The keyboard 101, switch panel 102, knob 103, and touch panel 105 shown in FIG. 2 are connected to the key scanner 206. The LCD 104 shown in FIG. 2 is connected to the LCD controller 207. The switch panel 102 includes mode selection switches and vocal sound source selection switches, which will be described later.

Furthermore, the sound source unit 204 and the voice synthesizer 205 are connected to D/A converters 211 and 212, respectively. The waveform data of instrument sounds output from the sound source unit 204 and the voice waveform data (singing voice waveform data) of singing voices output from the voice synthesizer 205 are converted into analog signals by the D/A converters 211 and 212, respectively, amplified by an amplifier 213, and then output from the speaker 214. The D/A converters 211 and 212, amplifier 213, and speaker 214 function as a vocalizer.

The CPU 201 controls the operation of the electronic musical instrument 2 shown in FIG. 1 by executing programs stored in the ROM 202 while using the RAM 203 as a work memory. The CPU 201 implements the function of a controller of the electronic device according to the present invention by executing the intonation control processing described below in cooperation with the programs stored in the ROM 202. The ROM 202 stores the programs, various fixed data, and the like.

In the present embodiment, the ROM 202 has a trained model 202a installed. The trained model 202a is generated by using machine learning on a plurality of datasets. The plurality of datasets includes musical score data for a plurality of phrases and singing voice waveform data for each of the plurality of phrases sung by a particular singer. The musical score data includes lyric data (lyric text information) and pitch data (including sound duration information). When lyric data (syllable data) and pitch data for any desired phrase (which may be a sung song) are input to the trained model 202a, the trained model infers singing voice parameter sets (referred to as singing voice information) to vocalize a singing voice equivalent to that vocalized when the singer whose performances have been used to train the trained model 202a would sing the input phrase.

The sound source unit 204 includes a waveform ROM storing waveform data for various timbres such as human voice, dog voice, and cat voice. This waveform data serves as waveform data for vocal sound sources (vocal sound source waveform data (excitation source data)) in the singing voice vocalization mode. The waveform ROM also includes waveform data for instrument sounds (instrument sound waveform data) such as piano, organ, synthesizer, string instruments, and wind instruments. The instrument sound waveform data can also be used as the vocal sound source waveform data.

In the normal mode, in accordance with control instructions from the CPU 201, the sound source unit 204 reads instrument sound waveform data from, for example, the waveform ROM (not shown) based on a key press note value indicating a pitch (note number) corresponding to a key pressed on the keyboard 101 (pressed key) and outputs the read instrument sound waveform data to the D/A converter 211. In the singing voice vocalization mode, in accordance with control instructions from the CPU 201, the sound source unit 204 reads waveform data from, for example, the waveform ROM (not shown) based on a key press note value of a key pressed on the keyboard 101 and outputs the read waveform data to the voice synthesizer 205 as the vocal sound source waveform data. Furthermore, based on the vocal sound source waveform data read from the waveform ROM and a pitch bend value, the sound source unit 204 generates vocal sound source waveform data, taking the pitch bend value into account. The sound source unit 204 is not limited to a pulse code modulation (PCM) sound source method, but may also employ other sound source methods, such as a frequency modulation (FM) sound source method.

Based on the singing voice information provided by the CPU 201 or based on both the singing voice information and the vocal sound source waveform data, the voice synthesizer 205 generates singing voice waveform data and outputs the generated singing voice waveform data to the D/A converter 212.

The sound source unit 204 and the voice synthesizer 205 may be configured by dedicated hardware such as a large-scale integration (LSI) chip or may be implemented by software through cooperation between the CPU 201 and the programs stored in the ROM 202. The controller according to the present application includes the CPU 201, sound source unit 204, and voice synthesizer 205.

The key scanner 206 constantly scans the pressed/released state of each key on the keyboard 101 shown in FIG. 2, as well as the operational states of the switch panel 102, the knob 103, and the touch panel 105. The key scanner 206 outputs the key press/release information for operated keys and the operational information for the switch panel 102, the knob 103, and the touch panel 105 to the CPU 201. The key press information includes key press note values of pressed keys. The key release information includes key release note values of released keys.

The LCD controller 207 is an integrated circuit (IC) that controls the display state of the LCD 104. The LCD 104 displays various information under the control of the CPU 201.

The communication unit 208 performs data transmission and reception with external devices such as the terminal device 3 connected via the communication network N such as the Internet or the communication interface I such as a Universal Serial Bus (USB) cable.

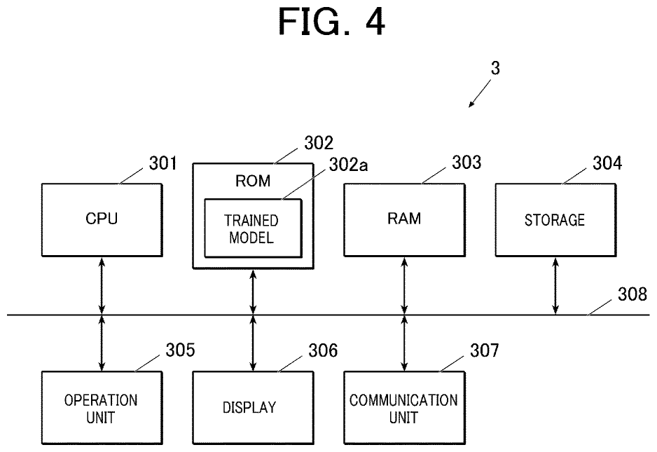

As illustrated in FIG. 4, the terminal device 3 is a computer including a CPU 301, a ROM 302, a RAM 303, a storage 304, an operation unit 305, a display 306, a communication unit 307, and the like, with each component connected via a bus 308. For example, a tablet personal computer (PC), a notebook PC, a smartphone, or the like may be applicable as the terminal device 3.

The ROM 302 of the terminal device 3 has a trained model 302a installed. The trained model 302a is the same machine learning model as the trained model 202a installed in the electronic musical instrument 2.

Next, an operation of the electronic musical instrument 2 when vocalizing a singing voice in the singing voice vocalization mode in response to a key press operation on the keyboard 101 will be described. In the conventional singing voice vocalization mode, a singing voice is vocalized at a pitch corresponding to a key pressed by the user. Consequently, for example, while the user continues pressing the same key, a singing voice is vocalized at the same pitch, which can be uninteresting and sometimes sound out of tune. Therefore, in the singing voice vocalization mode according to the present embodiment, the user can specify an intonation note level for each syllable, and a singing voice reflecting the intonation based on the intonation note level is vocalized.

Here, intonation refers to raising and lowering pitch. By specifying the intonation note level, intonation can be applied by raising or lowering the pitch of each syllable in a phrase on a note-by-note basis. Furthermore, using the f0 difference value described later, intonation can be applied by shifting (raising or lowering) the pitch of each frame (detailed later) in a phrase on a pitch-by-pitch basis.

To perform in the singing voice vocalization mode, the user selects the singing voice vocalization mode via a predetermined operation on the switch panel 102 of the electronic musical instrument 2 to instruct the shift to the singing voice vocalization mode. Next, the user selects a vocal sound source used for vocalizing a singing voice via a predetermined operation on the switch panel 102. As the vocal sound source, either the vocal sound source waveform data (first sound source) based on the trained model 302a (trained model 202a) or the vocal sound source waveform data (second sound source) output by the sound source unit 204 can be selected. The first sound source is a sound source of the singer's voice when the trained model 302a (trained model 202a) is generated. The second sound source is a sound source prepared in advance in the sound source unit 204, such as human voice, animal voice, or instrument sound.

The CPU 201 shifts the operation mode to the singing voice vocalization mode when the singing voice vocalization mode is selected via the operation on the switch panel 102. Furthermore, when a vocal sound source is selected via the operation on the switch panel 102, the CPU 201 sets the information on the selected vocal sound source as the vocal sound source to be used for vocalization (storing the information in the RAM 203).

Next, the user inputs any desired lyric data (syllable data) and pitch data that he/she wishes the electronic musical instrument 2 to vocalize in the singing voice vocalization mode using a dedicated application or the like on the terminal device 3. Lyric data and pitch data for a plurality of phrases may be stored in the storage 304, and the user may select lyric data and pitch data for any desired phrase from those stored in the storage 304. The pitch data may be a fixed value, such as E4. The pitch data includes information on the duration of sound corresponding to each syllable in the lyric data.

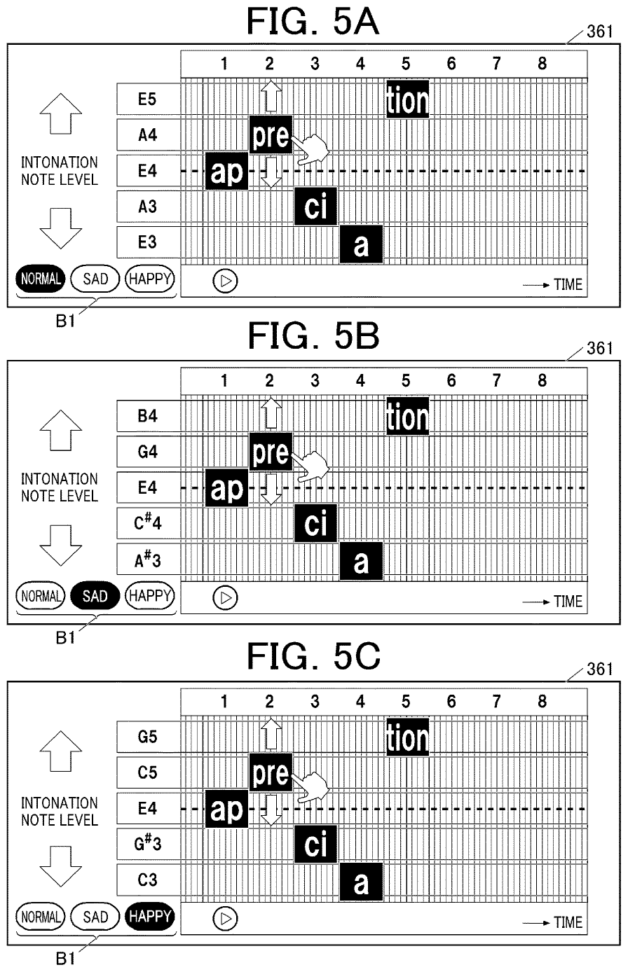

When the terminal device 3 receives an input of the lyric data and pitch data for any desired phrase to be vocalized in the singing voice vocalization mode, the CPU 301 displays an intonation note setting screen 361 on the display 306. The intonation note setting screen 361 is for setting the intonation note level for each syllable of the lyric data in response to a user operation. As illustrated in FIGS. 5A to 5C, on the intonation note setting screen 361, the vertical axis represents the pitch corresponding to each of five intonation note levels, and the horizontal axis represents the time axis. Along the horizontal axis, character sets containing respective syllables included in the lyric data (in FIGS. 5A to 5C, “ap”, “pre”, “ci”, “a”, and “tion”) are displayed in sequence along the time axis.

Here, the intonation note level includes, for example, five levels using E4 as the reference (normal), followed by slightly higher, higher, slightly lower, and lower. Sets (combinations) of multiple pitches corresponding to the respective five intonation note levels are preset. In the present embodiment, three types of sets are preset according to the emotional expression (Normal, Sad, Happy (Angry)).

As a pitch set for the intonation note level corresponding to the emotional expression “Normal”, for example, “E3-A3-E4-A4-E5” is provided, as illustrated in FIG. 5A. These pitches span a range of two octaves, centered on E4, extending one octave above and one octave below. As a pitch set for the intonation note level corresponding to the emotional expression “Sad”, for example, “A #3-C#4-E4-G4-B4” is provided, as illustrated in FIG. 5B. These pitches span a range of one octave, centered on E4, extending half an octave above and half an octave below. As a pitch set for the intonation note level corresponding to the emotional expression “Happy (Angry)”, for example, “C3-G #3-E4-C5-G5” is provided, as illustrated in FIG. 5C. These pitches span a range of 2.5 octaves, with E4 as the reference. That is, selecting “Sad” for the emotional expression sets a generally weak intonation, while selecting “Happy (Angry)” sets a generally strong intonation. The intonation note setting screen 361 displays, for example, emotional expression selection buttons B1. When the user presses one of the emotional expression selection buttons B1 to select an emotional expression, the CPU 301 switches the pitch set for the intonation note level to be used according to the selected emotional expression.

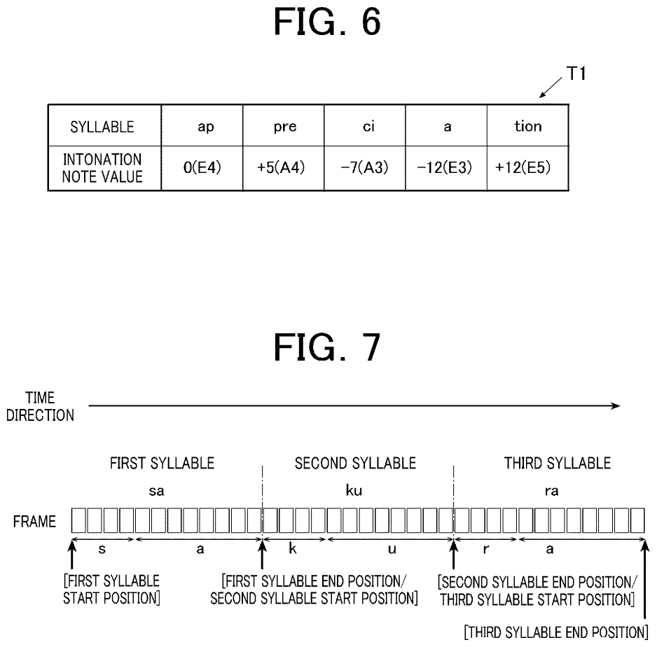

The intonation note setting screen 361 initially displays character sets containing respective syllables at the reference intonation note level positions. The user can change (set) the intonation note levels by sliding (sliding operation) the character sets containing the respective syllables up or down. Alternatively, the intonation note levels may be color-coded, with each character set containing a syllable displayed in a color corresponding to its intonation note level. This allows the user to easily grasp the intonation note level set for each syllable. The CPU 301 stores the pitch corresponding to the intonation note level set for each syllable as an intonation note value, expressed as a relative value with the reference pitch set to 0, in an intonation note setting table T1 (see FIG. 6).

Thus, on the intonation note setting screen 361, the pitch for vocalizing each syllable of the lyric data can be set to one of the five intonation note levels. The electronic musical instrument 2 intonation during vocalization based on the intonation note level set for each syllable. This enables vocalization with intonation even while the user continues to press the same key.

After the intonation note level for each syllable is set on the intonation note setting screen 361 and the intonation note setting table T1 is generated, the CPU 301 generates pitch data based on the intonation note setting table T1. The CPU 301 then inputs the generated pitch data and lyric data into the trained model 302a to infer singing voice parameter sets. In this step, the CPU 301 converts the pitch data (note number) into pitch (Hz) and inputs the pitch into the trained model 302a. The CPU 301 transmits the intonation note setting table T1 and the inferred singing voice parameter sets, which are the singing voice information, to the electronic musical instrument 2 via the communication unit 307.

Here, the singing voice information will be described. Each segment obtained by dividing a phrase (sung song) into predetermined time units in the time direction is called a frame. The trained model 302a generates singing voice parameters on a frame-by-frame basis. That is, the singing voice information for a single phrase includes a plurality of frame-based singing voice parameters (singing voice parameter sets in a time series). In the present embodiment, for example, 5 ms is defined as one frame. One frame is defined as the length of one sample multiplied by 225 when a phrase is sampled at a predetermined sampling frequency (e.g., 44.1 kHz). The frame-based singing voice parameters include spectral parameters (the frequency spectrum envelope of the vocalized sound) and fundamental frequency f0 parameters (the base pitch frequency of the vocalized sound, which may also be expressed as the excitation source).

Furthermore, the frame-based singing voice parameters include syllable information. FIG. 7 is an illustrative diagram showing the relationship between frames and syllables. As illustrated in FIG. 7, a voice in a phrase includes a plurality of syllables (in FIG. 7, the first syllable to the third syllable). Each syllable is vocalized over a plurality of consecutive frame segments in the time direction. The syllable start position and the syllable end position (both representing positions in the time direction) for each syllable within a phrase can be identified based on the frame position (i.e., the frame number from the beginning). The singing voice parameters of the frames corresponding to the syllable start position and syllable end position for each syllable in the singing voice information include information such as the Nth syllable start frame and the Nth syllable end frame (where N is a natural number).

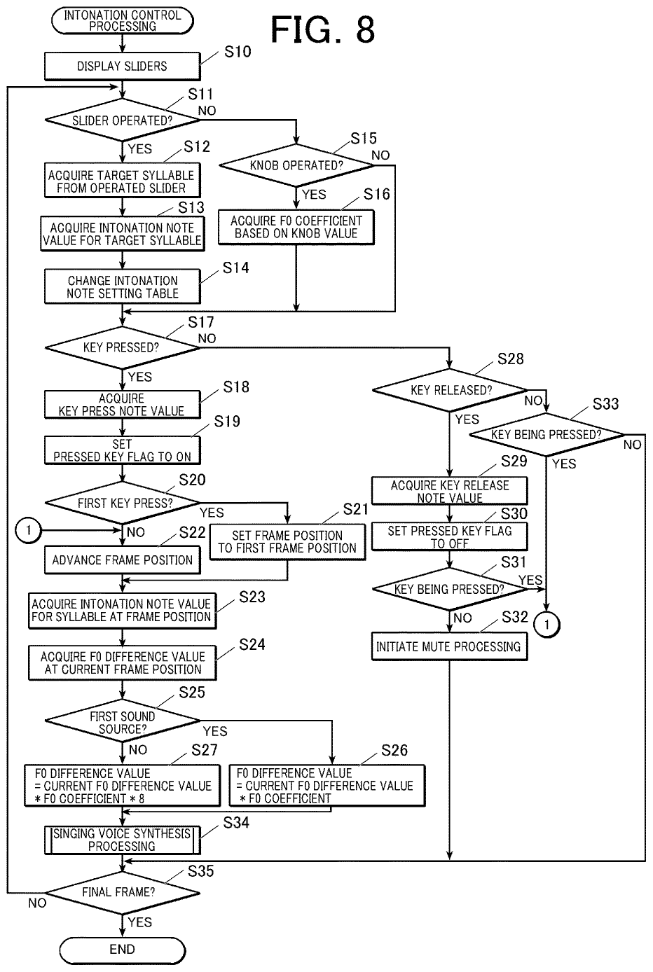

When the electronic musical instrument 2 receives the singing voice information from the terminal device 3 via the communication unit 208, the CPU 201 stores the received intonation note setting table T1 and the singing voice information in the RAM 203. Then, the CPU 201 initiates the intonation control processing illustrated in FIG. 8. The intonation control processing executed is through the cooperation between the CPU 201 and the programs stored in the ROM 202.

First, the CPU 201 displays sliders on the LCD 104 based on the intonation note setting table T1 (step S10). Each of the sliders is an operation unit that allows the intonation note level for each syllable to be specified. For example, the CPU 201 displays a screen on the LCD 104 (e.g., a screen substantially the same as the intonation note setting screen 361 illustrated in FIGS. 5A to 5C) on which the sliders are arranged to specify the intonation note level for each syllable of the lyric data along the time axis, with the vertical direction representing the intonation note level and the horizontal direction representing the time axis. The slider for each syllable is displayed at a position corresponding to the intonation note value specified by the intonation note setting table T1.

Next, the CPU 201 determines whether a slider operation has been detected by the key scanner 206 (step S11). If the CPU 201 determines that a slider operation has been detected (step S11; YES), the CPU 201 acquires the target syllable to be changed from the operated slider (step S12) and acquires the intonation note value from the position of the operated slider (step S13). Then, the CPU 201 changes the intonation note value for the target syllable in the intonation note setting table T1 (step S14) and advances the processing to step S17.

On the other hand, if the CPU 201 determines that no slider operation has been detected by the key scanner 206 (step S11; NO), the CPU 201 determines whether an operation on the knob 103 has been detected by the key scanner 206 (step S15). If the CPU 201 determines that an operation on the knob 103 has been detected by the key scanner 206 (step S15; YES), the CPU 201 acquires the f0 coefficient based on the knob value corresponding to the position of the operated knob (step S16) and advances the processing to step S17. The f0 coefficient is a factor to be multiplied by the f0 difference value to adjust the magnitude of the f0 difference value. The f0 difference value represents the pitch deviation (Hz) from the original pitch. The f0 coefficient can be calculated, for example, using the following (Equation 1).

f0 coefficient=knob value÷64 (Equation 1)
where the knob value ranges from 0 to 127.

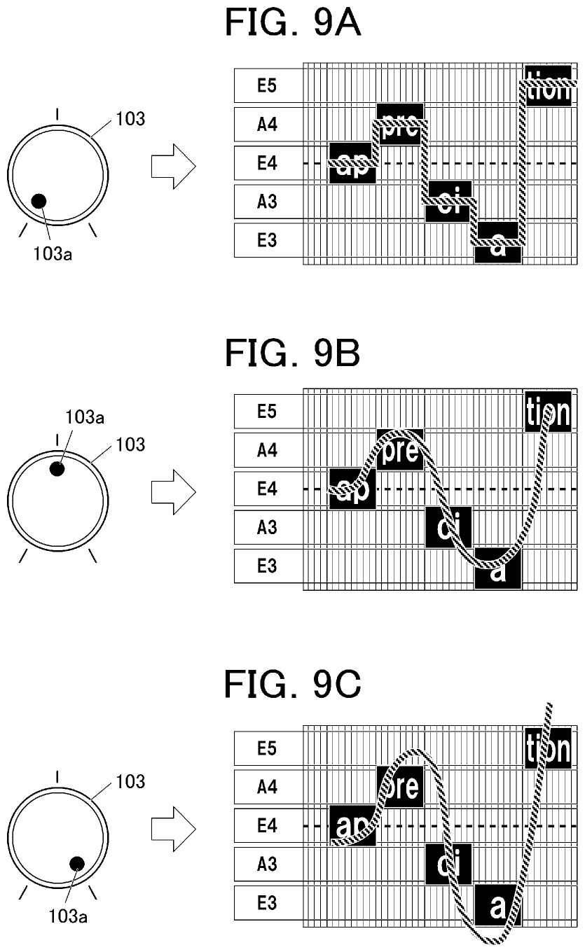

FIGS. 9A to 9C are schematic diagrams illustrating the respective positions of an indicator 103a of the knob 103 and the respective pitch changes of the character sets “ap”, “pre”, “ci”, “a”, and “tion”, with lines bearing a shaded pattern, vocalized when the indicator 103a is at the respective positions. For example, when the knob 103 is rotated to the left to set the knob value to 0, the f0 coefficient becomes 0. In this case, as illustrated in FIG. 9A, the pitch deviation from the original pitch (in FIGS. 9A to 9C, the pitch corresponding to the specified intonation note level) becomes zero, and each syllable is adjusted to be vocalized at the original pitch without intonation. For example, when the knob 103 is rotated to a central position to set the knob value to an intermediate value, the f0 coefficient becomes one. In this case, as illustrated in FIG. 9B, the f0 difference value is adjusted so that the pitch deviation (pitch variation) of the original singer is largely maintained during vocalization. For example, when the knob 103 is rotated to the right position and the knob value is set to the maximum value, the f0 coefficient becomes approximately two. In this case, as illustrated in FIG. 9C, the f0 difference value is adjusted so that the pitch deviation (pitch variation) of the original singer is emphasized during vocalization. As will be described in detail later, the f0 difference value may be further emphasized.

If the key scanner 206 determines that no operation on the knob 103 has been detected (step S15; NO), the CPU 201 advances the processing to step S17.

In step S17, the CPU 201 determines whether a key press on any key on the keyboard 101 has been detected by the key scanner 206 (step S17). If the CPU 201 determines that a key press on any key on the keyboard 101 has been detected (step S17; YES), the CPU 201 acquires the key press note value (first pitch data) of the pressed key (step S18) and sets a pressed key flag for the pressed key to ON (step S19). Here, the pressed key flag is provided corresponding to the note of each key on the keyboard 101 and is set to ON in a region corresponding to the key being pressed. The pressed key flags are stored in RAM 203 and are all initialized to OFF at the start of the intonation control processing.

Next, the CPU 201 determines whether the detected key press is the first key press (step S20). If the CPU 201 determines that the detected key press is the first key press (step S20; YES), the CPU 201 sets the frame position to be processed to the first frame position (step S21) and advances the processing to step S23. If the CPU 201 determines that the detected key press is not the first key press (step S20; NO), the CPU 201 advances the frame position (step S22) and advances the processing to step S23.

In step S23, the CPU 201 acquires the intonation note value corresponding to the syllable at the current frame position from the intonation note setting table T1 (step S23). Next, the CPU 201 acquires the f0 difference value corresponding to the current frame position output from the trained model (step S24). The pitch (frequency) of each frame is given by the following (Equation 2).

Frequency at Frame Position=Fundamental Frequency f0 Parameter+Difference Frequency (Equation 2)

The CPU 201 acquires, as the f0 difference value, the difference frequency added to this fundamental frequency f0 parameter.

Next, the CPU 201 determines whether the first sound source is selected as the vocal sound source (step S25). If the CPU 201 determines that the first sound source is selected as the vocal sound source (step S25; YES), the CPU 201 acquires the f0 difference value as the value obtained by multiplying the current f0 difference value by the aforementioned f0 coefficient (step S26) and advances the processing to step S34. Here, the first sound source is the vocal sound source waveform data based on the trained model 302a (trained model 202a) and is a sound source based on the singer's voice. Therefore, the value obtained by multiplying the current f0 difference value by the f0 coefficient is acquired as the f0 difference value without further emphasis, thereby adding intonation that utilizes the singer's natural intonation.

On the other hand, if the CPU 201 determines that the first sound source is not selected as the vocal sound source (that the second sound source is selected) (step S25; NO), the CPU 201 acquires the f0 difference value as the value obtained by multiplying the current f0 difference value by the aforementioned f0 coefficient and then multiplying that result by eight (step S27) and advances the processing to step S34. Here, the second sound source is not the vocal sound source waveform data based on the trained model 302a (trained model 202a), but rather a sound source generated by the sound source unit 204 in response to a key press. Therefore, the value obtained by multiplying the current f0 difference value by the f0 coefficient is further emphasized to exaggerate the intonation and add interest. In the present embodiment, the emphasis coefficient is fixed at eight, but the emphasis coefficient may be of any value other than eight. Furthermore, this coefficient may be set suitably by the user.

On the other hand, in step S17, if the CPU 201 determines that no key press on any key on the keyboard 101 has been detected (step S17; NO), the CPU 201 determines whether a key release on any key on the keyboard 101 has been detected (step S28).

If the CPU 201 determines that a key release on any key on the keyboard 101 has been detected (step S28; YES), the CPU 201 acquires the key release note value, which is the note number of the released key (step S29) and sets the pressed key flag for the released key to OFF (step S30). Next, the CPU 201 refers to the pressed key flags to determine whether there is a key being pressed (step S31). If the CPU 201 determines that there is a key being pressed (step S31; YES), the CPU 201 advances the processing to step S22 and executes steps S22 to S27 and step S34. If the CPU 201 determines that there is no key being pressed (step S31; NO), the CPU 201 initiates mute processing (step S32) and advances the processing to step S35. In step S32, the CPU 201 initiates processing to gradually reduce the volume of the amplifier 213 until the volume reaches zero.

On the other hand, if the CPU 201 determines in step S28 that no key release on any key on the keyboard 101 has been detected (step S28; NO), the CPU 201 refers to the pressed key flags to determine whether there is a key being pressed (step S33). If the CPU 201 determines that there is a key being pressed (step S33; YES), the CPU 201 advances the processing to step S22 and executes steps S22 to S27 and step S34. If the CPU 201 determines that there is no key being pressed (step S33; NO), the CPU 201 advances the processing to step S35.

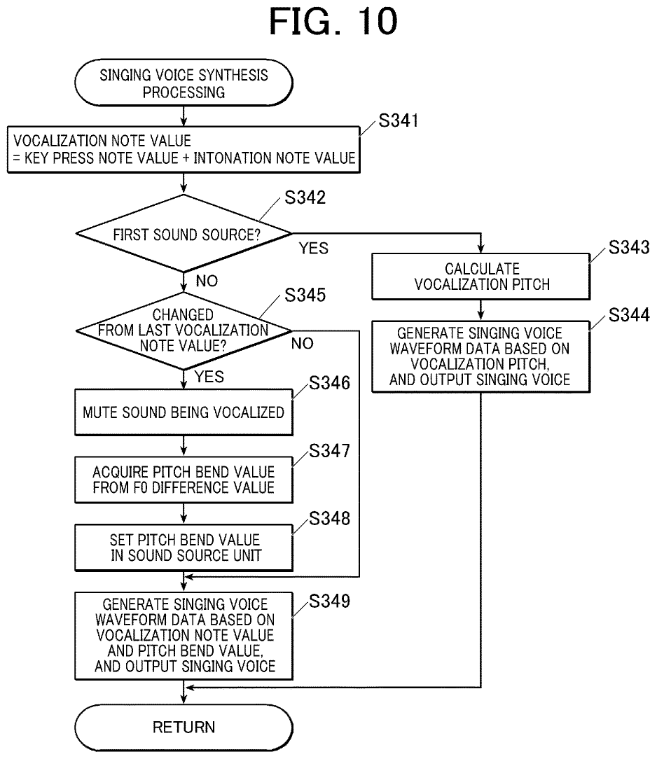

In step S34, the CPU 201 executes singing voice synthesis processing (step S34). As illustrated in FIG. 10, in the singing voice synthesis processing, the CPU 201 first calculates a vocalization note value (step S341). The vocalization note value is pitch data (second pitch data) of a sound to be actually vocalized, obtained by adding the intonation note value corresponding to the syllable at the current frame position to the key press note value. The CPU 201 calculates the intonation note value by referring to the intonation note setting table T1.

Next, the CPU 201 determines whether the first sound source is selected as the vocal sound source (step S342). If the CPU 201 determines that the first sound source is selected as the vocal sound source (step S342; YES), the CPU 201 calculates a vocalization pitch (Hz) (step S343). The vocalization pitch is calculated by converting the vocalization note value to frequency and adding the f0 difference value, which represents the pitch deviation of the singer whose singing voice has been learned by the trained model 202a (302a). The vocalization pitch can be calculated using the following (Equation 3).

Vocalization Pitch=440×2\hat{ }((Vocalization Note Value 69)/12)+f0 Difference Value (Equation 3)
where the symbol \hat{ }denotes exponentiation.

Next, the CPU 201 causes the voice synthesizer 205 to generate singing voice waveform data (voice waveform data) based on the calculated vocalization pitch and outputs (vocalizes) a singing voice via the D/A converter 212, amplifier 213, and speaker 214 based on the generated singing voice waveform data (step S344), then advances the processing to step S35 in FIG. 8. Here, for example, the CPU 201 generates singing voice parameters using the trained model 202a based on the calculated vocalization pitch and the current syllable and causes the voice synthesizer 205 to generate the singing voice waveform data based on the generated singing voice parameters. This enables vocalization of a singing voice similar to that of the aforementioned singer.

On the other hand, if the CPU 201 determines that the second sound source is selected as the vocal sound source (step S342; NO), the CPU 201 determines whether the calculated vocalization note value has changed from the previously calculated vocalization note value (step S345). Note that when the syllable changes due to the advancement of the frame position, the calculated vocalization note value changes from the previously calculated vocalization note value.

If the CPU 201 determines that the calculated vocalization note value has changed from the previously calculated vocalization note value (step S345; YES), the CPU 201 issues a note-off (mute) for the currently vocalized (previous) sound (step S346). Next, the CPU 201 converts the f0 difference value acquired in step S24 into a pitch bend value (step S347) and sets the acquired pitch bend value in the sound source unit 204 (step S348). Next, the CPU 201 causes the sound source unit 204 to generate vocal sound source waveform data reflecting the f0 difference value based on the vocalization note value and the pitch bend value. The CPU 201 then causes the voice synthesizer 205 to generate singing voice waveform data based on the generated vocal sound source waveform data and the singing voice parameters (spectral parameters) at the current frame position. The CPU 201 then causes the D/A converter 212, amplifier 213, and speaker 214 to output (vocalize) a singing voice based on the generated singing voice waveform data (step S349). Thereafter, the CPU 201 advances the processing to step S35 in FIG. 8.

In step S35 in FIG. 8, the CPU 201 determines whether the current frame position is the final frame (step S35). If the CPU 201 determines that the current frame position is not the final frame (step S35; NO), the CPU 201 returns the processing to step S11 in FIG. 8. If the CPU 201 determines that the current frame position is the final frame (step S35; YES), the CPU 201 terminates the intonation control processing.

As described above, the CPU 201 of the electronic musical instrument 2 acquires: a key press note value (first pitch data), which corresponds to a key press by the user; lyric data that includes a plurality of syllables; and an intonation note level for each of the plurality of syllables (or each character set containing each of the plurality of syllables) specified by the user from among a plurality of intonation note levels corresponding to a respective plurality of pitches. Then, the CPU 201 generates voice waveform data corresponding to the syllable based on a vocalization note value (second pitch data) obtained by changing the key press note value (first pitch data) according to the intonation note level for each syllable and causes the vocalizer to vocalize based on the generated voice waveform data. Thus, each syllable (each character set containing each syllable) can be vocalized with the intonation desired by the user.

Furthermore, plurality of pitch sets is associated with a respective plurality of emotional expressions. Each of the plurality of pitch sets includes a plurality of pitches corresponding to the respective plurality of intonation note levels. The CPU 201 acquires an emotional expression selected by the user. A vocalization note value is obtained by changing the key press note value, which corresponds to the key press by the user, according to the pitch set associated with the selected emotional expression. Thus, each syllable can be vocalized with the intonation corresponding to the emotional expression desired by the user. Furthermore, the pitch range for the plurality of intonation note levels differs depending on the emotional expression. Therefore, each syllable can be vocalized with the intonation within the pitch range corresponding to the emotional expression selected by the user.

Furthermore, the plurality of intonation note levels includes five intonation note levels. This makes it easy for the user to specify the intonation note level for each syllable.

Furthermore, the CPU 201 displays, on the LCD 104, the sliders that allow the intonation note levels for the respective syllables to be specified. Therefore, the electronic musical instrument 2 enables the user to specify the intonation note levels for the respective syllables.

Furthermore, the CPU 201 sequentially causes the syllables in the lyric data to be vocalized, causes the vocalizer to mute the voice being vocalized when causing a new syllable to be vocalized, generates voice waveform data corresponding to the new syllable based on the vocalization note value according to the intonation note level of the new syllable, and causes the vocalizer to vocalize based on the generated voice waveform data. Thus, when the syllable is changed, the voice corresponding to the intonation note level of the new syllable can be vocalized.

Furthermore, the CPU 201 generates voice waveform data based on voice parameters generated by inputting the lyric data and pitch data based on the intonation note levels corresponding to the syllables into a trained model obtained by using machine learning on teacher data containing a voice waveform of a certain singer. Thus, a voice reflecting the pitch deviation of the singer can be vocalized by the vocalizer.

Furthermore, the electronic musical instrument 2 includes the knob 103 that adjusts the magnitude of the pitch deviation, and the CPU 201 generates voice waveform data with a deviated pitch based on a user operation on the adjuster. This enables the user to adjust the pitch deviation of the singer to be larger or smaller.

The description in the above embodiment is a preferred example of the electronic device, electronic device system, and intonation control method according to the present invention, and the present invention is not limited thereto.

For example, in the above embodiment, the CPU 201 of the electronic musical instrument 2 obtains a vocalization note value by changing a key press note value, which corresponds to a key press by the user, according to the intonation note level for each syllable, generates voice waveform data corresponding to the syllable based on the obtained vocalization note value, and causes the vocalizer to vocalize based on the generated voice waveform data, thereby realizing the function as a controller. However, the CPU 301 of the terminal device 3 may also realize the function as a controller. For example, when the electronic musical instrument 2 transmits a key press note value to the terminal device 3 via the communication unit 208 and the terminal device 3 receives the key press note value via the communication unit 307, the CPU 301 may obtain a vocalization note value by changing the received key press note value according to the intonation note level for each syllable. Based on the obtained vocalization note value, the CPU 301 may generate voice waveform data corresponding to the syllable. Then, the CPU 301 may transmit the generated voice waveform data to the electronic musical instrument 2 via the communication unit 307, allowing the vocalizer of the electronic musical instrument 2 to vocalize.

Furthermore, in the above embodiment, specifying the intonation note level for each syllable, generating the intonation note setting table T1, generating pitch data based on the intonation note setting table T1, and inferring a singing voice parameter set based on the generated pitch data and lyric data are performed by the terminal device 3. However, this series of processes may also be executed by the electronic musical instrument 2.

Furthermore, the volume and sound distortion may be changed in combination with the emotional expression selected by the user. For example, when the emotional expression is “Normal”, the volume and sound distortion are set to “Medium”; when the emotional expression is “Sad”, the volume and sound distortion are set to “Weak”; and when the emotional expression is “Happy (Angry)”, the volume and sound distortion are set to “Strong” for vocalization. For example, the CPU 201 changes the volume by varying the volume level during vocalization via the amplifier 213 to predetermined levels of medium, weak, and strong (medium, small, large) according to the emotional expression. Furthermore, the CPU 201 changes the sound distortion by altering the timbre of the excitation source (vocal sound source waveform data) according to the emotional expression. This is achieved using a method common in PCM sound sources, such as velocity split, which alters the timbre.

Furthermore, in the above embodiment, the sliders that allow for settings of the intonation note level are software sliders displayed on the LCD 104, but the sliders may be hardware sliders. Furthermore, the knob that adjusts the pitch deviation may be a software knob displayed on the LCD 104.

Furthermore, in the above embodiment, the case in which the electronic musical instrument 2 as the electronic device (first electronic device) is an electronic keyboard instrument is taken as an example, but the present invention is not limited thereto. For example, the electronic musical instrument 2 may also be another electronic instrument such as an electronic string instrument or an electronic wind instrument. Furthermore, the electronic device (first electronic device) is not limited to an electronic musical instrument. The electronic device is not particularly limited as long as the electronic device is capable of allowing pitch to be specified via input elements such as sliders, pads, and switches. Furthermore, the electronic device system 1 may also include a plurality of first electronic devices capable of allowing pitch to be specified.

Furthermore, in the above embodiment, an example in which a semiconductor memory such as a ROM or a hard disk is used as a computer-readable medium for the program according to the present invention has been disclosed, but the present invention is not limited thereto. As another computer-readable medium, an SSD or a portable recording medium such as a CD-ROM can be used. In addition, a carrier wave may also be used as a medium for providing data of the program according to the present invention via a communication line.

The detailed configuration and detailed operation of each component of the electronic device, electronic device system, and intonation control method may be appropriately modified within the scope that does not deviate from the spirit of the invention.

The above describes embodiments of the present invention. However, the technical scope present invention is not limited to the above embodiments and is defined based on the claims. Furthermore, the scope of equivalents encompassing changes to the claims that are not essential to the present invention are also included within the technical scope of the present invention.

1. An electronic device comprising at least one processor, wherein the at least one processor:
acquires:
first pitch data corresponding to a pitch specification operation by a user on an operating element;
syllable data that includes a plurality of syllables; and
an intonation note level for each of the plurality of syllables, the intonation note level being specified by the among a plurality of intonation note levels user from corresponding to a respective plurality of pitches;
generates voice waveform data corresponding to the each of the plurality of syllables based on second pitch data obtained by changing the first pitch data according to the intonation note level for the each of the plurality of syllables; and
causes a vocalizer to vocalize based on the voice waveform data.

2. The electronic device according to claim 1, wherein
a plurality of pitch sets is associated with a respective plurality of emotional expressions, each of the plurality of pitch sets including a plurality of pitches corresponding to the respective plurality of intonation note levels, and
the at least one processor
acquires one of the plurality of emotional expressions selected by the user,
wherein the second pitch data is obtained by changing the first pitch data according to the pitch set associated with the acquired one of the plurality of emotional expressions.

3. The electronic device according to claim 2, wherein a pitch range for the plurality of intonation note levels differs depending on the plurality of emotional expressions.

4. The electronic device according to claim 1, wherein the plurality of intonation note levels includes five intonation note levels.

5. The electronic device according to claim 1, further comprising a display that displays an operation unit that allows the intonation note level for the each of the plurality of syllables to be specified.

6. The electronic device according to claim 1, wherein the at least one processor:
sequentially causes the plurality of syllables in the syllable data to be vocalized;
causes the vocalizer to mute a voice being vocalized when causing a new syllable among the plurality of syllables to be vocalized; and
generates, based on the second pitch data according to the intonation note level for the new syllable, the voice waveform data corresponding to the new syllable.

7. The electronic device according to claim 1, wherein the at least one processor generates the voice waveform data based on a voice parameter that is generated by inputting the syllable data and pitch data into a trained model, the pitch data being based on the plurality of intonation note levels corresponding to the respective plurality of syllables, the trained model being obtained by using machine learning on teacher data containing a voice waveform of a certain singer.

8. The electronic device according to claim 1, further comprising an adjuster that adjusts a magnitude of pitch deviation, wherein the at least one processor generates, based on a user operation on the adjuster, the voice waveform data with the pitch deviation.

9. An electronic device system comprising:
a first electronic device that includes an operating element allowing a pitch to be specified; and
a second electronic device, wherein
the second electronic device includes at least one processor, and
the at least one processor:
acquires:
first pitch data corresponding to a pitch specification operation by a user on the operating element;
syllable data that includes a plurality of syllables; and
an intonation note level for each of the plurality of syllables, the intonation note level being specified by the user from among a plurality of intonation note levels corresponding to a respective plurality of pitches; and
causes a vocalizer to vocalize based on voice waveform data corresponding to the each of the plurality of syllables, the voice waveform data being generated based on second pitch data obtained by changing the first pitch data according to the intonation note level for the each of the plurality of syllables.

10. An intonation control method executed by a computer, comprising:
acquiring:
first pitch data corresponding to a pitch specification operation by a user on an operating element;
syllable data that includes a plurality of syllables; and
an intonation note level for each of the plurality of syllables, the intonation note level being specified by the user from among a plurality of intonation note levels corresponding to a respective plurality of pitches;
generating voice waveform data corresponding to the each of the plurality of syllables based on second pitch data obtained by changing the first pitch data according to the intonation note level for the each of the plurality of syllables; and
causing a vocalizer to vocalize based on the voice waveform data.

11. The intonation control method according to claim 10, wherein
a plurality of pitch sets is associated with a respective plurality of emotional expressions, each of the plurality of pitch sets including a plurality of pitches corresponding to the respective plurality of intonation note levels, and
the method further comprises
acquiring one of the plurality of emotional expressions selected by the user,
wherein the second pitch data is obtained by changing the first pitch data according to the pitch set associated with the acquired one of the plurality of emotional expressions.

12. The intonation control method according to claim 11, wherein a pitch range for the plurality of intonation note levels differs depending on the plurality of emotional expressions.

13. The intonation control method according to claim 10, wherein the plurality of intonation note levels includes five intonation note levels.

14. The intonation control method according to claim 10, further comprising causing a display to display an operation unit that allows the intonation note level for the each of the plurality of syllables to be specified.

15. The intonation control method according to claim 10, further comprising:
sequentially causing the plurality of syllables in the syllable data to be vocalized;
causing the vocalizer to mute a voice being vocalized when causing a new syllable among the plurality of syllables to be vocalized; and
generating, based on the second pitch data according to the intonation note level for the new syllable, the voice waveform data corresponding to the new syllable.

16. The intonation control method according to claim 10, further comprising generating the voice waveform data based on a voice parameter that is generated by inputting the syllable data and pitch data into a trained model, the pitch data being based on the plurality of intonation note levels corresponding to the respective plurality of syllables, the trained model being obtained by using machine learning on teacher data containing a voice waveform of a certain singer.

17. The intonation control method according to claim 10, further comprising generating, based on a user operation on an adjuster that adjusts a magnitude of pitch deviation, the voice waveform data with the pitch deviation.
